(19) United States
(12) Patent Application Publication
(10) Pub. No.: US 2022/0111431 A1
(43) Pub. Date: Apr. 14, 2022

(54) Device With Multiple Coined Areas Having Multiple Mechanical Properties

(71) Applicant: A.K. Stamping Company, Inc., Mountainside, NJ (US)

(72) Inventor: Arthur Kurz, Mountainside, NJ (US)

(73) Assignee: A.K. Stamping Company, Inc., Mountainside, NJ (US)

(21) Appl. No.: 17/497,841

(22) Filed: Oct. 8, 2021

Related U.S. Application Data
(60) Provisional application No. 63/089,418, filed on Oct. 8, 2020.

(51) Int. Cl. B21D 28/26

(52) U.S. Cl. CPC B21D 28/26

(57) ABSTRACT

The present disclosure relates to a device with multiple coined areas having multiple mechanical properties, and systems and methods for manufacturing such a device. The device can include a central channel section with a spine and one or more legs, a flexible spring section extending from the spine at a first end of the channel section, and one or more compliant pins extending from the one or more legs at a second end of the central channel section. The device is integrally formed from a single piece of stock material having first mechanical properties and one or more of the spring section and the compliant pins are coined to produce one or more different mechanical properties.

### CROSS-REFERENCE TO RELATED APPLICATIONS

This application claims the benefit of U.S. Provisional Patent Application No. 63/089,418, filed Oct. 8, 2020, the entire disclosure of which is hereby expressly incorporated by reference.

### BACKGROUND

### Field of the Disclosure

The present disclosure relates to a device with multiple coined areas having multiple mechanical properties, and systems and methods for manufacturing such a device. More specifically, the present disclosure relates to manufacturing processes that include coining one or more sections of the component to produce one or more different mechanical properties.

### Related Art

Various industries require components having multiple mechanical properties. This has been addressed in the past by manufacturing portions of the device separately and then subsequently attaching them together (e.g., by mechanical or chemical means) to form a single component.

### SUMMARY

The present disclosure relates to a device, such as a connector, with multiple coined areas having multiple mechanical properties and systems and methods for the production thereof. The device includes a central channel section including a spine and one or more legs that curve away from the spine, a flexible spring section extending from the spine at a first end of the channel section, and one or more compliant pins extending from the one or more legs at a second end of the central channel section opposite the flexible spring section. The central channel section, the flexible spring section, and the one or more compliant pins are integrally formed and each can have different mechanical properties. The spine and the first and second legs of the central channel extend along a central axis of the device and can form a generally “C” shaped cross-sectional area and the flexible spring section can have a generally sinusoidal cross-sectional area. Additionally, the central channel section can have a first thickness and a first hardness rating, the flexible spring section can have a second thickness and a second hardness rating, and the one or more compliant pins can have a third thickness and a third hardness rating.

A system for producing the device having multiple mechanical properties is also disclosed and includes a metal stamping press and a progressive die configured to be received by the metal stamping press and to receive stock material having a first mechanical characteristic. The progressive die includes a first station having one or more piercing tools configured to pierce one or more registration holes in the stock material. A second station includes one or more first trimming tools configured to trim the compliant pins of the device from the stock material and a second trimming tool configured to trim leading and trailing edges of the spring section from the stock material. A third station includes a first coining tool configured to coin the compliant pins and impart a second mechanical property to the compliant pins. A fourth station includes a second coining tool configured to coin the spring section and impart a third mechanical property to the spring section. The system can further include a fifth station including a final trimming tool configured to trim the edges of the spring section of the device to a final shape, a cutting tool disposed between fifth and sixth stations of the progressive die configured to cut the channel section from the stock material, an eight station including a forming tool configured to form the spring section to have a generally sinusoidal cross-sectional area, a ninth station including a bending tool configured to form one or more of the legs of the channel section, and a tenth station including one or more cutting tools configured to remove web material connecting the device from the stock material, thereby separating the device from the web material.

A method for forming the device having multiple mechanical properties is also provided. The method includes loading stock material having a first mechanical property into a first station of the progressive die and punching one or more registration holes in the stock material. The material is then advanced to a second station of the progressive die for rough trimming of the compliant pins and rough trimming of a leading edge of a spring section of the device. A third station of the progressive die includes rough trimming a trailing edge of the spring section and coining the compliant pins, thereby work hardening the compliant pins and imparting a second mechanical property thereto. The material is advanced to a fourth station for final trimming of the compliant pins and coining of the spring section, thereby work hardening the spring section and imparting a third mechanical property thereto. The method can also include the steps of advancing the stock material to a fifth station and final trimming the leading edge of the spring section to a final shape, advancing the stock material to a sixth station, final trimming the trailing edge of the spring section to a final shape, and cutting a leading edge of the channel section of the device from the stock material, advancing the stock material to a seventh station and cutting a trailing edge of the channel section from the stock material, advancing the stock material to an eighth station and stamping the spring section such that the spring section has a generally sinusoidal cross-sectional area, advancing the stock material to a ninth station and bending the legs in the channel section such that the channel section has a generally “C” shaped cross-sectional area, and advancing the stock material to a tenth station and removing web material connecting the device to the stock material, thereby separating the device from the web material.

### BRIEF DESCRIPTION OF THE DRAWINGS

The features of the disclosure will be apparent from the following Detailed Description, taken in connection with the accompanying drawings, in which:

FIG. 1 is a perspective view of a component according to the present disclosure having multiple mechanical properties;

FIG. 2 is a side view of the component of FIG. 1;

FIG. 3 is a top view of the component of FIG. 1;

FIG. 4 is a cross-sectional view (taken along line D-D of FIG. 3) of a spring section of the component of FIG. 1;

FIG. 5 is a cross-sectional view (taken along line E-E of FIG. 3) of a channel section of the component of FIG. 1;

FIG. 6 is a cross-sectional view (taken along line G-G of FIG. 3) of compliant pins of the component of FIG. 1;

FIG. 7 is a partial perspective view showing an exemplary system of the present disclosure for manufacturing the component of FIG. 1;

FIG. 8 is a top view of the system of FIG. 7;

FIG. 9 is a side view of the system of FIG. 7;

FIG. 10 is a detailed view (of area H-H of FIG. 9) of a die tool of the system of FIG. 7 for forming the spring section of the component of FIG. 1; and

FIG. 11 is a flowchart illustrating process steps carried out by the manufacturing system of FIG. 7.

### DETAILED DESCRIPTION

The present disclosure relates to a device with multiple coined areas having multiple mechanical properties, and systems and methods for manufacturing such a device. More specifically, the present disclosure relates to manufacturing processes that include coining one or more sections the component to produce one or more different mechanical properties, as discussed in detail below in connection with the figures.

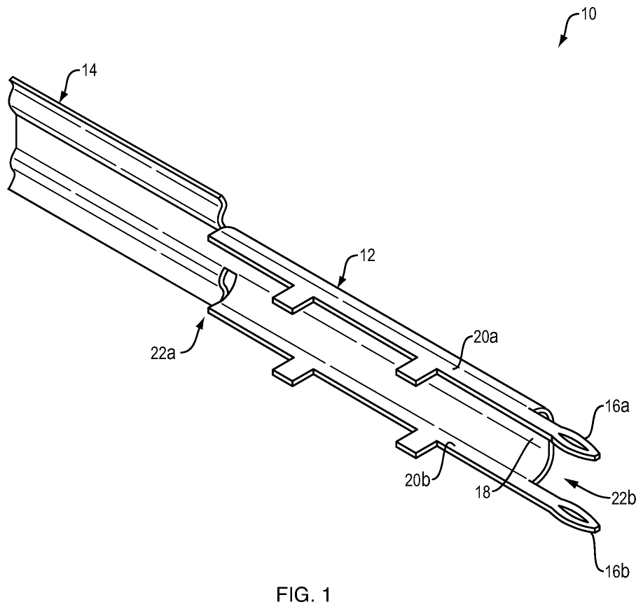

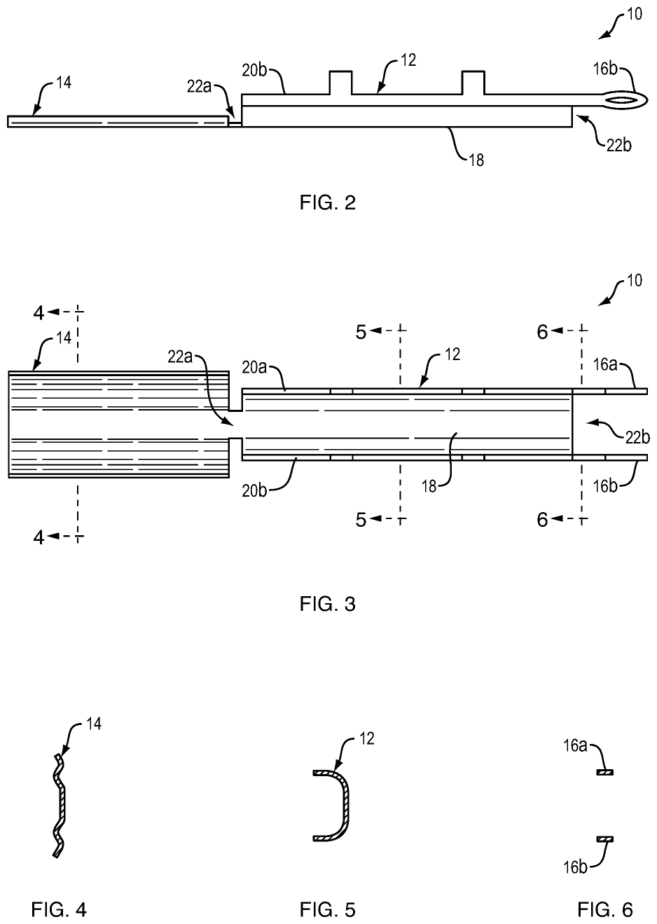

FIGS. 1-6 illustrate an exemplary component 10 according to the present disclosure having multiple mechanical properties. More specifically, FIG. 1 is a perspective view of the component 10, FIG. 2 is a side view of the component 10, FIG. 3 is a top view of the component 10, FIG. 4 is a first cross-sectional view (taken along line D-D of FIG. 3) of the component 10, FIG. 5 is a second cross-sectional view (taken along line E-E of FIG. 3) of the component 10, and FIG. 6 is a third cross-sectional view (taken along line G-G of FIG. 3) of the component 10.

The component 10 can be of a unitary construction, integrally formed from a single piece of material (e.g., cold-rolled steel or the like), and can include a central channel section 12, a spring section 14 at one side, and first and second compliant pins 16a and 16b at the other side. The channel section 12 can include a spine 18 and first and second legs 20a and 20b that curve away from the spine 18, forming a generally “C” shaped cross-sectional area (see, e.g., FIG. 5) extending along the axis of the component. The spring section 14 can extend from the spine 18 of the channel section 12 at a first end 22a thereof and can be generally flexible as shown by the generally sinusoidal cross-sectional area (see, e.g., FIG. 4). The first and second compliant pins 16a and 16b can extend from the first and second legs 20a and 20b, respectively, at a second end 22b of the channel section 12. Additionally, as will be discussed in greater detail herein, the channel section 12, the spring section 14, and the first and second compliant pins 16a and 16b can have different physical and/or mechanical properties. For example, the channel section 12 can have a cross-sectional thickness of 0.0040 inches and be “¼ hard” (e.g., as opposed to fully annealed steel or other metal), the spring section 14 can have a cross-sectional thickness of 0.0036 inches and be “½ hard,” and the first and second compliant pins 16a and 16b can have a cross-sectional thickness of 0.0030 inches and be “¾ hard.” It is noted that the component 10 is an exemplary component that can be produced using the systems and methods of the present disclosure and those of ordinary skill in the art will understand that the systems and methods of the present disclosure can be utilized to produce other components having various shapes, sizes, and configurations.

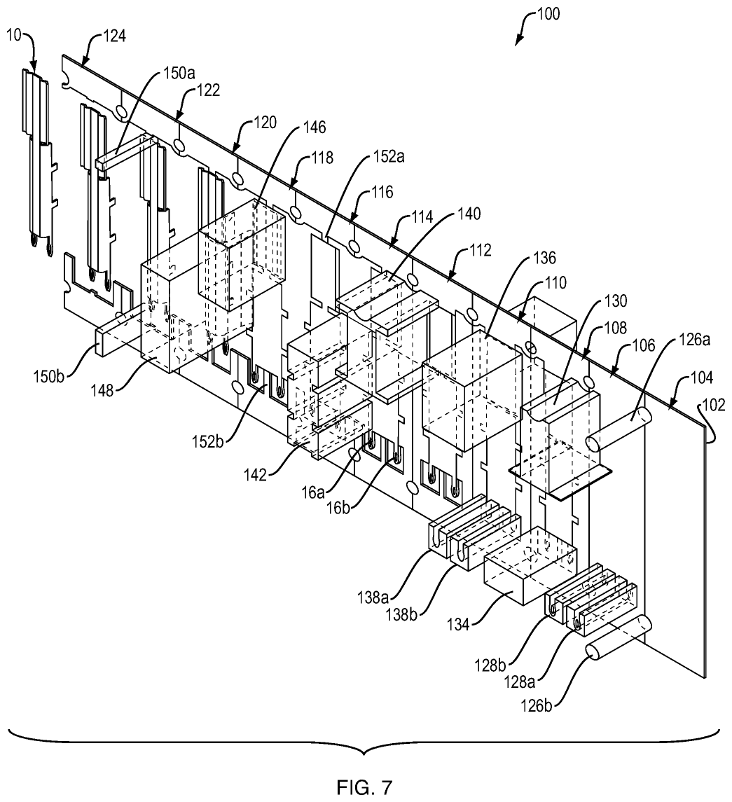

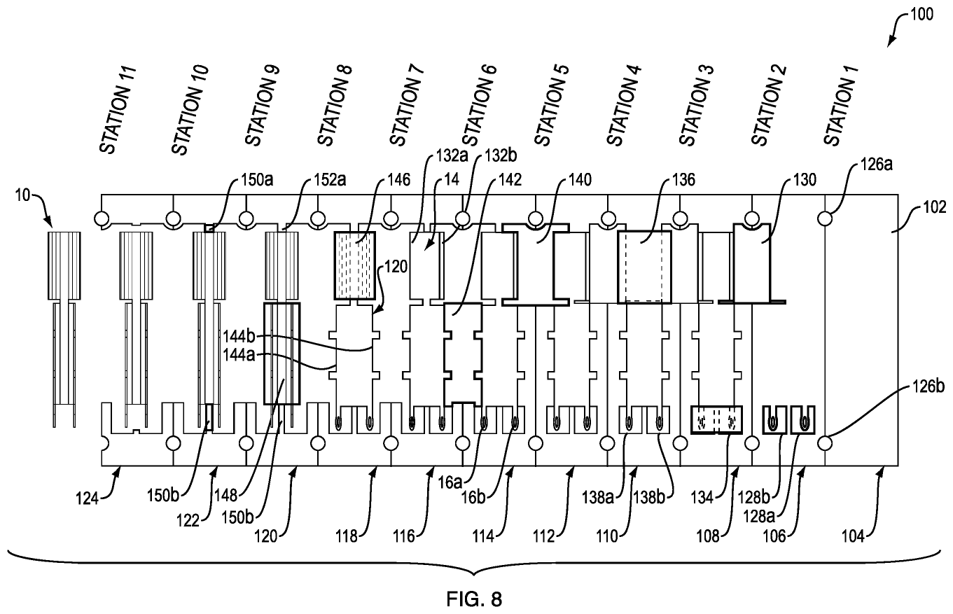

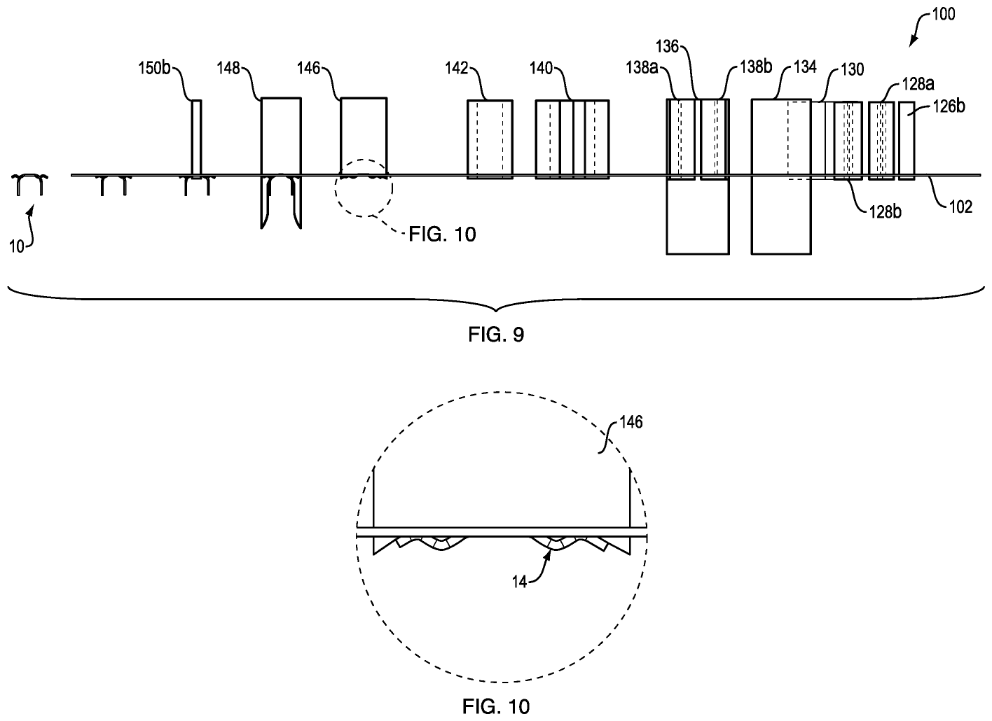

FIGS. 7-10 illustrate an exemplary system 100 of the present disclosure for manufacturing a component having multiple mechanical properties, for example the component 10, discussed in connection with FIGS. 1-6. FIG. 7 is a partial perspective view of the system 100, FIG. 8 is a top view of the system 100, FIG. 9 is a side view of the system 100, and FIG. 10 is a detailed view (of area H-H of FIG. 9) of a die tool of the system 100 for forming the spring section 14 of the component 10.

The system 10 of the present disclosure can include a plurality of metal stamping tools that are arranged within multiple stations of a progressive stamping die (not shown) that is, in turn actuated by a mechanical press. As used herein, the terms “tool” or “tools” can refer to, but are not limited to, trimming tools, coining tools, bending tools, blanking tools, piercing tools, shearing tools, and the like. As will be familiar to those of ordinary skill in the art, the press generally includes a reciprocating ram which punches against a workpiece (e.g., sheet metal) held in place by the die. The shape of the die, and the tooling therein, determines the final shape of the workpiece. A progressive die advances the workpiece through multiple stations (having various tools) to complete all necessary stamping operations and typically ends with cutting the completed part from the sheet metal stock.

FIGS. 7-10 illustrate a piece of stock 102 (e.g., sheet metal) as it is advanced through the progressive die and formed into the component 10, discussed in connection with FIGS. 1-6. The stock has a first mechanical characteristic. As shown, the die can have multiple stations, including for example, a first station 104, a second station 106, a third station 108, a fourth station 110, a fifth station 112, a sixth station 114, a seventh station 116, an eighth station 118, a ninth station 120, a tenth station 122, and an eleventh station 124. The first station 104 can include first and second piercing tools 126a and 126b for forming (e.g., registration) holes in the stock 102, which can be used to move the stock 102 through the stations of the progressive die. The second station 106 can include rough trimming tools 128a and 128b for rough trimming (e.g., establishing the general, but not final, form) the compliant pins 16a and 16b and a rough trimming tool 130 for rough trimming the leading, and subsequently trailing, edges 132a and 132b of the spring section 14. The third station 108 can include a coining tool 134 for coining (e.g., striking and reducing the thickness) the compliant pins 116a and 116b to impart a second mechanical characteristic to the pins. The fourth station 110 can include a coining tool 136 for coining the spring section 114 to impart a third mechanical characteristic to the spring section, and first and second final trimming tools 138a and 138b for trimming the compliant pins 116a and 116b to their final shape. The fifth station 112 can include a final trimming tool 140 for trimming the leading, and subsequently trailing, edges 132a and 132b of the spring section 14 to their final shape. A cutting tool 142 can be disposed between the sixth station 114 and the seventh station 116 for cutting the leading, and subsequently trailing, edges 144a and 144b of the channel section 112, thereby freeing the channel section 112 from the stock 102. The eighth station 118 can include a stamping tool 146 for forming the spring section 14 (see, e.g., FIG. 10). As best shown in FIG. 9, the ninth station 120 can include a bending tool 148 for bending the legs 20a and 20b away from the spine 18, thereby forming the final shape of channel section 12. The tenth station 122 can include first and second cutting tools 150a and 150b to remove remaining web material 152a and 152b connecting the component 10 to the stock 102, thereby separating the final component 10 from the stock 102. The component 10 can exit the progressive die at the eleventh station 124 by way of a “drop through” in the die, or any other mechanism for final part removal.

It is noted that the system 100 shown and described herein is an exemplary system for manufacturing the component 10 and those of ordinary skill in the art will understand that the systems and methods of the present disclosure can be modified and utilized to produce other components having various shapes, sizes, and configurations, with various mechanical properties in the component.

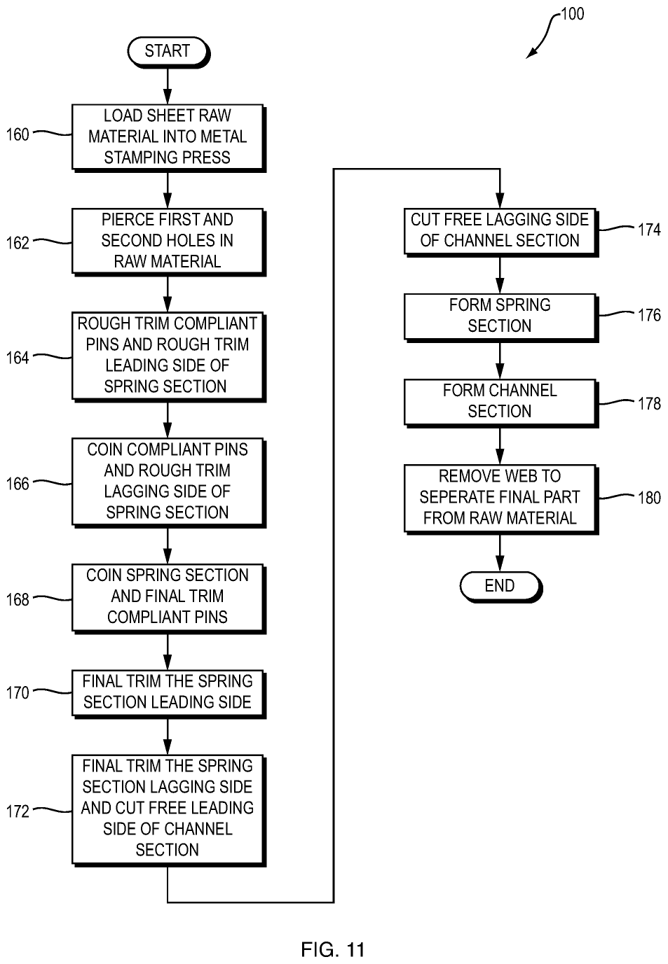

FIG. 11 is a flowchart illustrating process steps carried out by the system 100, described in connection with FIGS. 7-11. In step 160, a sheet of raw material (e.g., stock 102) is inserted into a progressive die of a metal stamping press. The raw material can be a sheet of ¼ hard cold-rolled steel having a thickness of 0.0040 inches, however, other materials having different physical dimensions and material characteristics can be used without departing from the spirit and scope of the present disclosure.

In step 162, the raw material enters the first station (e.g., station 104) of the progressive die, where first and second holes are punched in the material. In step 164, the material advances to the second station (e.g., station 106), where a first trimming tool is used to is used to rough trim the compliant pins 16a and 16b and a second trimming tool is used to rough trim the leading side of the spring section 14. In step 166, the material advances to the third station (e.g., station 108), where the second trimming tool from the second station is used to rough trim the lagging side of the spring section 14 and a coining tool is used to coin the compliant pins 16a and 16b. For example, the compliant pins 16a and 16b can be coined by 0.001 inches, thereby reducing their thickness to 0.003 inches. Notably, performing a coining operation on the material serves to “work harden” the coined areas, thereby altering the material properties of the material in same areas. For example, by coining the compliant pins 16a and 16b by 0.001 inches and thereby reducing their thickness to 0.003 inches, the hardness of the compliant pins 16a and 16b can be increased from the original ¼ hard of the stock material to % hard. Those of skill in the art will understand that these are merely specific examples and varying degrees of work hardening can be performed according to the systems and methods of the present disclosure.

In step 168, the material advances to the fourth station (e.g., station 110), where a final trimming tool can be used to trim the compliant pins 16a and 16b to their final shapes and a coining tool is used to coin the spring section 14. For example, the spring section 14 can be coined by 0.0004 inches, thereby reducing its thickness to 0.0036 inches. As discussed above, performing a coining operation on the material serves to “work harden” the coined area, thereby altering its material properties. For example, by coining the spring section 14 by 0.0004 inches and thereby reducing its thickness to 0.0036 inches, the hardness of the spring section 14 can be increased from ¼ hard to ½ hard.

In step 170, the material advances to the fifth station (e.g., station 112), where a final trimming tool is used to trim the leading side of the spring section 14 to its final dimensions. In step 172, the material advances to the sixth station (e.g., station 114), where the final trimming tool from the fifth station is used to trim the lagging side of the spring section 14 to its final dimensions and a cutting tool is used to cut the leading side of the channel section 12 free from the stock. In step 174, the material advances to the seventh station (e.g., station 116), where the cutting tool from the sixth station (e.g., cutting tool 142) is used to cut the lagging side of the channel section 12 free from the stock.

In step 174, the material advances to the eighth station (e.g., station 118), where a stamping tool is used to form any desired curvature of the spring section 14 (see, e.g., tool 146 as shown and described in connection with FIG. 10). In step 176, the material advances to the ninth station (e.g., station 120), where a bending tool is used to form the final shape of the channel section 12 (see, e.g., tool 148 as shown and described in connection with FIG. 9). In step 180, the material advances to the tenth station (e.g., station 122), where any remaining web material, joining the component 10 to the stock material, is removed with a cutting tool, thereby separating the final component 10 from the stock material. The finalized component can then be removed from the progressive die.

Having thus described the invention in detail, it is to be understood that the foregoing description is not intended to limit the spirit or scope thereof. It will be understood that the embodiments of the present invention described herein are merely exemplary and that a person skilled in the art may make any variations and modification without departing from the spirit and scope of the invention. All such variations and modifications, including those discussed above, are intended to be included within the scope of the invention.

What is claimed is:

1. A device having multiple mechanical properties, comprising:
a central channel section including a spine and one or more legs that curve away from the spine;
a flexible spring section extending from the spine at a first end of the channel section; and
one or more compliant pins extending from the one or more legs at a second end of the central channel section opposite the flexible spring section;
the central channel section, the flexible spring section, and the one or more compliant pins being integrally formed and each having different mechanical properties.

2. The device of claim 1, wherein the spine and the first and second legs form a generally “C” shaped cross-sectional area.

3. The device of claim 2, wherein the first and second legs extend along a central axis of the device.

4. The device of claim 1, wherein the flexible spring section has a generally sinusoidal cross-sectional area.

5. The device of claim 1, wherein the central channel section has a first thickness and a first hardness rating.

6. The device of claim 5, wherein the flexible spring section has a second thickness and a second hardness rating.

7. The device of claim 6, wherein the one or more compliant pins have a third thickness and a third hardness rating.

8. A system for producing a device having multiple mechanical properties, comprising:
a metal stamping press; and
a progressive die configured to be received by the metal stamping press and to receive stock material having a first mechanical characteristic, the progressive die comprising:
a first station having one or more piercing tools configured to pierce one or more registration holes in the stock material;
a second station including one or more first trimming tools configured to trim one or more compliant pins of the device from the stock material and a second trimming tool configured to trim edges of a spring section of the device from the stock material;
a third station including a first coining tool configured to coin the one or more compliant pins and impart a second mechanical property to the one or more compliant pins; and
a fourth station including a second coining tool configured to coin the spring section and impart a third mechanical property to the spring section.

9. The system of claim 8, comprising a fifth station including a final trimming tool configured to trim the edges of the spring section of the device to a final shape.

10. The system of claim 9, comprising a first cutting tool disposed between fifth and sixth stations of the progressive die, the cutting tool configured to cut a channel section from the stock material.

11. The system of claim 10, comprising an eight station including a forming tool configured to form the spring section to have a generally sinusoidal cross-sectional area.

12. The system of claim 11, comprising a ninth station including a bending tool configured to form one or more legs of the channel section.

13. The system of claim 12, comprising a tenth station including one or more cutting tools configured to remove web material connecting the device from the stock material, thereby separating the device from the web material.

14. A method for forming a device having multiple mechanical properties, comprising the steps of:
loading stock material into a progressive die and punching one or more registration holes in the stock material, the stock material having a first mechanical property;
rough trimming one or more compliant pins of the device, and rough trimming a leading edge of a spring section of the device;
rough trimming a trailing edge of the spring section, and coining the one or more compliant pins, thereby work hardening the compliant pins and imparting a second mechanical property thereto; and
final trimming the one or more compliant pins to a final shape, and coining the spring section, thereby work hardening the spring section and imparting a third mechanical property thereto.

15. The method of claim 14, comprising the step final trimming the leading edge of the spring section to a final shape.

16. The method of claim 15, comprising final trimming the trailing edge of the spring section to a final shape, and cutting a leading edge of a channel section of the device from the stock material.

17. The method of claim 16, comprising cutting a trailing edge of the channel section from the stock material.

18. The method of claim 17, comprising stamping the spring section such that the spring section has a generally sinusoidal cross-sectional area.

19. The method of claim 18, comprising ending one or more legs in the channel section such that the channel section has a generally “C” shaped cross-sectional area.

20. The method of claim 19, comprising removing web material connecting the device to the stock material, thereby separating the device from the web material.
